(19) United States
(12) Patent Application Publication
(10) Pub. No.: US 2011/0078991 A1
(43) Pub. Date: Apr. 7, 2011

(54) Replaceable Mower Cutting Component

(76) Inventor: James Lindmeyer, Hutchinson, MN (US)

(21) Appl. No.: 12/894,992

(22) Filed: Sep. 30, 2010

Related U.S. Application Data
(60) Provisional application No. 61/247,684, filed on Oct. 1, 2009.

(51) Int. Cl. A01D 34/73

(52) U.S. Cl. 56/295

(57) ABSTRACT

A vegetation cutting apparatus includes a rotatable member having an anchor at a first axis of rotation, and a cutting component that is removably coupled to the anchor. The cutting component may be rotatably coupled to the anchor about a second axis of rotation, and the cutting component may be couplable to, and decouplable from the anchor without tools. In some embodiments, the cutting component is fabricated from a plastic material.

### CROSS-REFERENCE TO RELATED APPLICATIONS

This application claims priority to U.S. Provisional Patent Application Ser. No. 61/247,684, filed on Oct. 1, 2009 and entitled “Replaceable Mower Cutting Component,” the content of which being incorporated herein in its entirety.

### FIELD OF THE INVENTION

The present invention relates to mowing equipment generally, and more particularly to a mowing apparatus utilizing easily replaceable and inexpensive cutting knives.

### BACKGROUND OF THE INVENTION

Powered vegetation cutting equipment may take on a variety of forms, and are typically implemented in applications most suitable to their respective capabilities. Example vegetation cutting equipment types include rotary blade mowers, flail-type mowers, sickle blade mowers, and so on. Typical rotary blade mowers may be used for residential and other relatively light-duty applications. Relatively heavy-duty vegetation cutting applications, such as the cutting of vegetation more than 6 inches tall or up to 4 inches in diameter may, for example, be most efficiently treated with flail mowers. Accordingly, use of flail mowers is common in large-scale operations, such as roadside vegetation cutting, cutting of vegetation adjacent to power lines, and other land-clearing tasks.

In one example, a flail mower uses a plurality of flails (“knives”) instead of blades. A flail may be defined as a relatively short piece of material that operates by beating (flailing) the vegetation to break it off at approximately a desired height. When the flails are operated at high speeds, vegetation cutting may be quite efficient. For example, flail mowers have a tendency to minimize the bunching and clumping of the cut material.

Flail mowers may be typically mounted to three point mount tractors, and in some cases are driven by the power take-off units of such tractors. Some flail mower units are capable of cutting vegetation of up to 4 inches in diameter. Flail mowers utilize a rotatable drum to which the cutting knives are secured. The rotatable drum may itself be coupled to an articulating arm or boom, which allows the flail mower to be moved into a variety of orientations as desired. Rotatable drums of flail mowers are available in a variety of widths, and may be used in combination with other rotatable drums to obtain a large overall cutting path of up to, for example, 300 inches.

Flail mowers are most often employed in applications involving relatively heavy vegetation and/or applications in which the throwing of objects during cutting is highly undesirable. Because the cutting knives on a flail mower typically rotate about an axis substantially parallel to the ground, cut material tends not to be propelled outwardly from the mowing equipment. Therefore, highway mowing and park maintenance crews often use flail mowers in areas with heavy trash and where there may be bystanders in an effort to minimize the likelihood of danger from thrown objects during cutting. Because flail mowers are often times utilized in heavy duty applications, the cutting knives may come into contact with large and/or immovable objects, such as rocks, garbage, fence posts, and the like, with some frequency Impacts between the cutting knives and such large objects may cause dulling or damage to the cutting knives, which reduces the overall capacity and effectiveness of the flail mower. Operators must then repair or replace the damaged cutting knives which, in current systems, is a labor-intensive process. Moreover, typical flail mower cutting knives are constructed of metal, such that replacement of the cutting knives is expensive.

It is therefore an object of the present invention to provide a cutting component useful in, for example, flail mowing applications, which cutting component is easily replaceable without tools.

It is another object of the present invention to provide a vegetation cutting apparatus utilizing a removable cutting component that is fabricated from plastic, and may be installed and removed from a rotatable member without tools.

It is a further object of the present invention to provide a replaceable cutting component that is easily removably secured to a rotatable member in a vegetation cutting apparatus, such as a rotary blade mower or a flail mower.

### SUMMARY OF THE INVENTION

By means of the present invention, replacement cutting blades may be easily and efficiently removably secured to a vegetation cutting apparatus. The operation of engagement and disengagement of such cutting components may be accomplished by hand, and without the use of tools. Moreover, the removable cutting components may be fabricated from a variety of materials, including durable and inexpensive plastic.

In one embodiment, a vegetation cutting apparatus includes a rotatable member having an anchor and a first axis of rotation, and a cutting component removably coupled to the anchor. The cutting component may be fabricated from a plastic material, and is rotatably coupled to the anchor about a second axis of rotation, wherein the cutting component is couplable to and decouplable from the anchor without tools. In some embodiments, the second axis of rotation is substantially parallel to the first axis of rotation.

In one embodiment, the operable coupling of the cutting component with the anchor includes a protrusion engaging with a receptacle, wherein the cutting component includes a main body and the protrusion. The protrusion may include a first portion with a first engaging dimension and a second portion with a second engaging dimension, the first engaging dimension being larger than the second engaging dimension. The second portion of the protrusion may extend between the main body and the first portion of the protrusion. The anchor may include the receptacle having a first section configured to removably receive the first and second portions of the protrusion, and a second section configured to removably receive only the second portion of the protrusion.

### BRIEF DESCRIPTION OF THE DRAWINGS

FIG. 1 is a schematic view of a vegetation cutting apparatus of the present invention;

FIG. 2A is an enlarged view of a portion of the vegetation cutting apparatus illustrated in FIG. 1;

FIG. 2B is an enlarged view of a portion of the vegetation cutting apparatus illustrated in FIG. 1;

FIG. 3 is an isolation view of a portion of the vegetation cutting apparatus illustrated in FIGS. 1 and 2;

FIG. 4 is an isolation view of a portion of the vegetation cutting apparatus illustrated in FIGS. 1 and 2;

FIG. 5 is a diagrammatical illustration of a portion of the vegetation cutting apparatus illustrated in FIGS. 1 and 2;

FIG. 6 is a top view of a portion of a vegetation cutting apparatus of the present invention;

FIG. 7 is a perspective view of a vegetation cutting apparatus of the present invention; and

FIG. 8 is a diagrammatical illustration of a portion of a vegetation cutting apparatus of the present invention.

### DETAILED DESCRIPTION OF THE PREFERRED EMBODIMENTS

The objects and advantages enumerated above together with other objects, features, and advances represented by the present invention will now be presented in terms of detailed embodiments described with reference to the attached drawing figures which are intended to be representative of various embodiments of the invention. Other embodiments and aspects of the invention are recognized as being within the grasp of those having ordinary skill in the art.

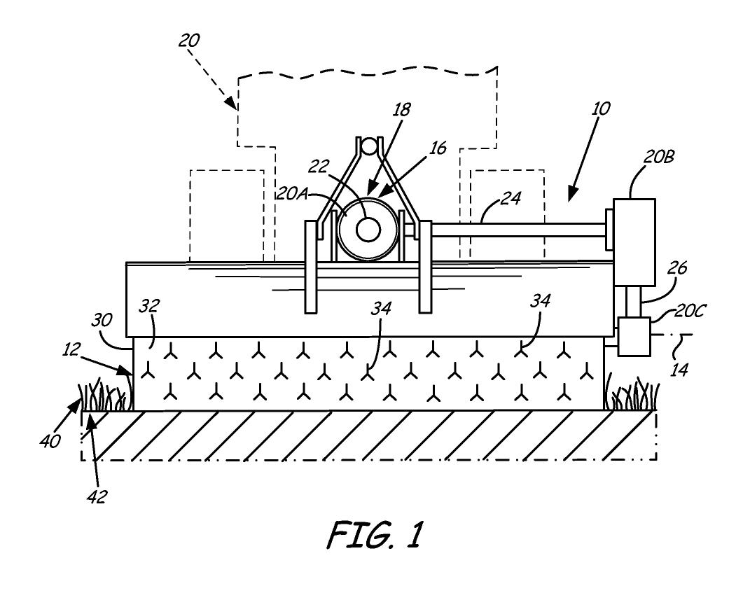

With reference now to the drawing figures, and first to FIG. 1, a vegetation cutting apparatus 10 includes a rotatable member 12 that is rotatably driven about a first axis of rotation 14 by a drive mechanism 16 that may be coupled to, for example, a power take-off unit 18 of a tractor 20. Other mechanisms, however, for driving rotatable member 12 about first axis 14 are contemplated by the present invention. In the illustrated embodiment, drive mechanism 16 utilizes geared couplings 20A, 20B, 20C to deliver rotational inertia from drive shaft sections 22, 24, 26 to rotatable member 12 about first axis of rotation 14. Techniques and apparatus for rotatably driving rotatable member 12, such as in a flail mowing application, are well understood in the art.

In the illustrated embodiment, rotatable member 12 may be a drum or rotor, as is commonly utilized in flail mowing applications. Rotatable member 12, in one embodiment, may therefore comprise a substantially cylindrical body 30 having an outer surface 32 to which cutting knives 34 may be secured. In operation, rotation of rotatable member 12 about first axis of rotation 14 causes cutting knives 34 to come into flailing contact with vegetation 40 at a position spaced from ground surface 42 to cut the vegetation 40 to a desired height from ground surface 42. Thus, cutting knives 34 perform the vegetation cutting, while rotatable member 12 serves as the mounting surface for such cutting knives 34.

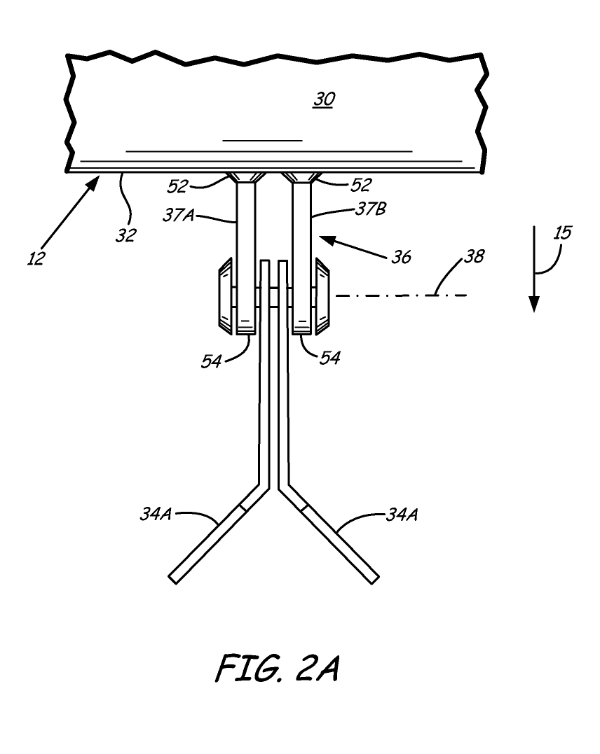

One embodiment of the invention is illustrated in the detailed view of FIG. 2A, wherein cutting knives 34A are removably secured to an anchor 36, which itself may be secured to outer surface 32 of rotatable member 12. In the illustrated embodiment, anchor 36 may include first and second anchor members 37A, 37B which are each individually secured to rotatable member 12 and oriented substantially parallel to one another in facilitating the removable coupling of cutting knives 34A thereto. However, it is to be understood that alternative embodiments of anchor 36 and cutting knives 34 may be employed while remaining within the scope of the present invention. For example, anchor 36 may comprise a single anchor member, to which one or more individual cutting knives 34 may be removably secured. Moreover, anchor 36 may be secured to outer surface 32 of rotatable member 12 at a single location, and yet provide a plurality of distinct anchor members 37A, 37B for use in removably securing one or more cutting knives 34 thereto.

A further embodiment of a cutting knife is illustrated in FIG. 2B, wherein cutting knife 34B is removably and rotatably coupled to anchor 36. Cutting knife 34B may have a cutting edge 75 which rotates about second axis of rotation 38 to cut vegetation. Cutting knife 34B may include one or more apertures 77 to minimize air resistance generated in the operable rotation of cutting knife 34B about first axis of rotation 14 and second axis of rotation 38. The minimization of air resistance in the operation of cutting knife 34B increases rotational speed of cutting knife of 34B, thereby enhancing the cutting efficiency of cutting knife 34B.

In one embodiment, anchor 36 may be fabricated from a metal, such as steel, and may be welded to outer surface 32 of body 30 or rotatable member 12. In other embodiments, however, anchor 36 may be integrally formed with rotatable member 12, and not separately secured thereto. In some cases, integration of anchor 36 with rotatable member 12 enhances the strength of anchor 36. However, Applicant contemplates that anchor 36 need not be integrally formed with rotatable member 12, and may instead by formed from separate pieces secured to rotatable member 12. In addition to welding, Applicant also contemplates a variety of other securement mechanisms for attaching anchor 36 to rotatable member 12. Example alternative mechanisms include adhesives, mechanical fasteners, interference fit arrangements, and the like. It should be understood that any known mechanism for securing anchor 36 to rotatable member 12 may be employed in the present invention.

Applicant also contemplates that anchor 36 may be fabricated from a wide variety of materials that provide sufficient strength in securing cutting knives 34 for vegetation cutting applications. For example, anchor 36 may be fabricated from any suitable metals, ceramics, composites, plastics, polymers, inorganic materials, and so on. Considerations in selecting the material for anchor 36 may include cost, strength, durability, weldability, and the like.

Cutting knives 34 constitute one or more cutting components useful in, for example, cutting vegetation. In one aspect of the present invention, cutting knives 34 may be fabricated from a plastic material, and may be molded into a desired configuration. It has been determined by the Applicant that plastic cutting knives 34 are adequate in vegetation cutting performance, and may be inexpensively manufactured. Moreover, plastic cutting knives 34 may be fabricated into configurations which facilitate the removable coupling of cutting knives 34 to anchor 36. In other embodiments, however, cutting knives 34 may be fabricated from non-plastic materials, such as metals, composites, ceramics, and the like.

Another aspect of the present invention includes the removable securement of the cutting component, such as cutting knives 34, to anchor 36. In conventional systems, cutting knives are secured to the respective anchors through difficult and/or cumbersome mechanisms which are. As described above, the cutting components may be desirably removed for repair or replacement. However, conventional mechanisms substantially prevent such a practice. As illustrated in FIGS. 2A and 2B, cutting knives 34 may be removably and rotatably coupled to anchor 36. In particular, cutting knives 34 may be rotatably coupled to anchor 36 about second axis of rotation 38, such that cutting knives 34 may operationally rotate about both first and second axes of rotation 14, 38. In some embodiments, second axis of rotation 38 is substantially parallel to first axis of rotation 14. In this way, cutting knives 34 may develop high angular velocities during the operational rotation of rotatable member 12 effectuate desired vegetation cutting. As will be described in greater detail hereinbelow, cutting knives 34 may be coupleable to, and decouplable from, anchor 36 without the use of tools. In other words, an operator may attach and detach cutting knives 34 to and from anchor 36 easily by hand, and without the need for tools. In one embodiment, such removable securement of cutting knives 34 to anchor 36 may be accomplished through a tortuous path interference fit.

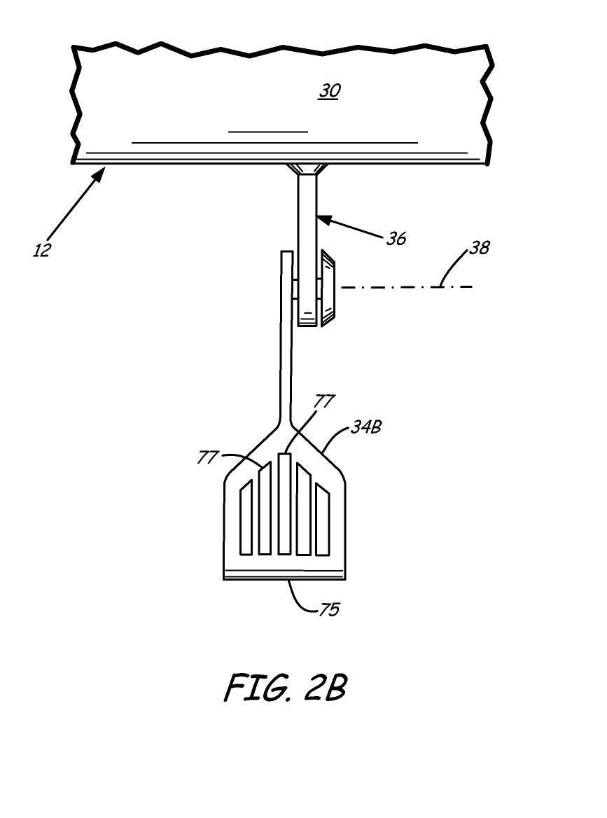

An example anchor 36 of the present invention is illustrated in FIG. 3 having first and second ends 52, 54 and a receptacle 56. As illustrated in FIG. 2, anchor 36 may be oriented with first end 52 toward rotatable member 12 and second end 54 away from rotatable member 12. In one embodiment, anchor 36 may be orthogonally oriented with respect to outer surface 32 of rotatable member 12. Receptacle 56 of anchor 36 includes a first section 58 and a second section 60 contiguous with one another through tortuous path 62. Receptacle 56 may be referred to as a “keyhole” design in which first section 58 has a first opening dimension 64 that is larger than a second opening dimension 66 of second section 60. Receptacle 56 transitions from first opening dimension 64 to second opening dimension 66 at neck portion 68, which also defines the transition from first section 58 to second section 60. The first and second opening dimensions 64, 66 of the keyhole design of receptacle 56 are complimentary with the configuration of cutting knives 34 to removably retain one or more cutting knives 34 at anchor 36. In the embodiment illustrated in FIG. 3, receptacle 56 is a slot extending through a thickness dimension “T” of anchor 36. It is contemplated, however, that receptacle 56 need not extend through an entire thickness dimension “T,” but rather merely provide a configuration for engagement with a portion of the cutting component, in this case cutting knives 34.

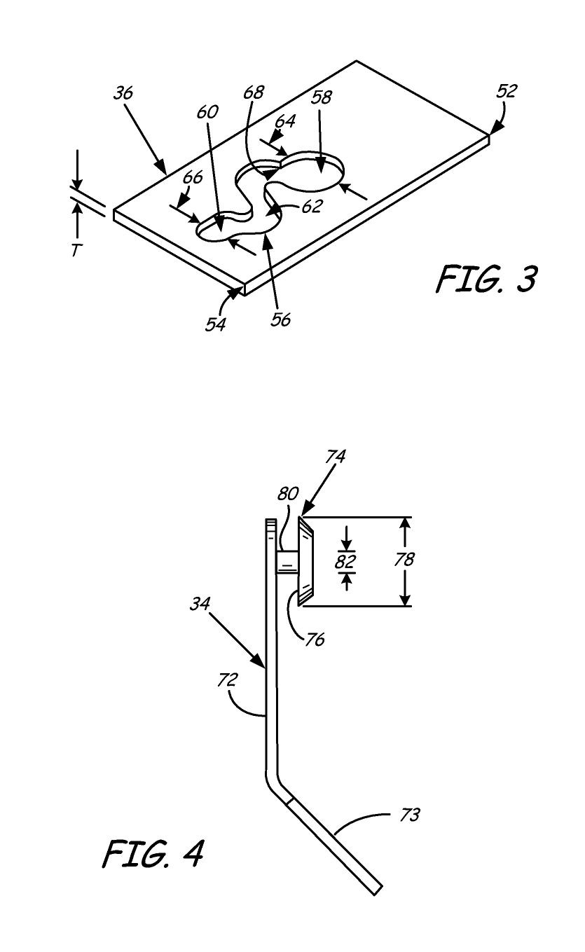

A cutting knife 34 is illustrated in isolation in FIG. 4, and includes a main body 72 and a protrusion 74 that is configured for removable engagement with receptacle 56 of anchor 36. In one embodiment, protrusion 74 may constitute a key that is configured for an interference fit within the keyhole design of receptacle 56. For example, protrusion 74 may include a first portion 76 having a first engaging dimension 78, and a second portion 80 having a second engaging dimension 82, with such engaging dimensions typically representing the largest width dimension of each respective first and second portions 76, 80 of protrusion 74. As illustrated in FIG. 4, second portion 80 of protrusion 74 extends between main body 72 of cutting knife 34 and first portion 76 of protrusion 74. Thus, the “key” design of protrusion 74 includes a relatively larger first portion 76 spaced from main body 72 by second portion 80, which has a smaller engaging dimension 82 than the first engaging dimension 78 of first portion 76. In some embodiments, first portion 76 may be substantially disc-shaped.

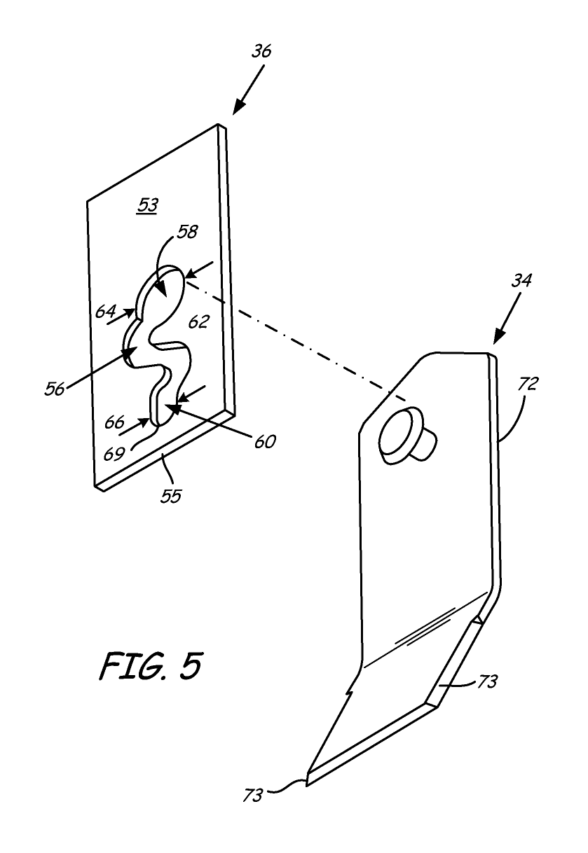

As illustrated in FIG. 5, first section 58 of receptacle 56 is configured to removably receive both said first and second portions 76, 80 of protrusion 74. To that end, first opening dimension 64 may be larger than first engaging dimension 78 (and also larger than second engaging dimension 82). First portion 76 of protrusion 74 may therefore be operably received in or through first section 58 of receptacle 56. In one embodiment, first portion 76 of protrusion 74 may be inserted through first section 58 of receptacle 56, such that protrusion 74 extends through receptacle 56 to an opposite side of anchor 36. Second opening dimension 66 may be substantially equal to, but slightly larger than, second engaging dimension 82, but smaller than first engaging dimension 78. In such a manner, second section 60 of receptacle 56 is configured to removably receive only second portion 80 of protrusion 74. To removably engage cutting knife 34 with anchor 36, therefore, second portion 80 of protrusion 74 is motivated along tortuous path 62 to end section 69 of receptacle 56. At this relative position, cutting knife 34 is prevented from direct disengagement from anchor 36 through the interference of first portion 76 of protrusion 74 with first surface 53 of anchor 36, as well as interference between main body 72 of cutting knife 34 and second surface 55 of anchor 36. Second portion 80 of protrusion 74 is rotatably retained within receptacle 56 about second axis of rotation 38.

As illustrated in FIGS. 2A and 2B, the rotational operation of rotatable member 12 results in a centrifugal or momentum force against cutting knives 34 along a direction 15 that is substantially normal to first axis of rotation 14. Such centrifugal force acting upon cutting knives 34 operably assists in maintaining second portion 80 of protrusion 74 positioned at end section 69 of receptacle 56. Moreover, the tortuous path 62 of receptacle 56 further inhibits displacement of second portion 80 along receptacle 56 toward first section 58. However, deliberate manipulation by a user of second portion 80 of protrusion 74 along tortuous path 62 of receptacle 56 enables the operator to selectively position protrusion 74 at first section 58 for disengagement of cutting knife 34 from anchor 36. Without such deliberate manipulation by the operator, however, Applicant has determined that spontaneous disengagement of cutting knife 34 from anchor 36 is extremely unlikely. In this manner, engagement and disengagement of cutting knife 34 with anchor 36 may be accomplished quickly and simply by hand, and without the need for tools.

Cutting knife 34 may assume a variety of configurations useful in cutting vegetation. In the embodiment illustrated in FIG. 4, cutting knife 34 includes one or more sharpened edges 73. In one embodiment, two cutting knives 34 may be positioned in back to back facing relationship, and coupled to a respective anchor 36, such as in the arrangement illustrated in FIG. 2. It is contemplated, however, that any number of cutting knives 34 may be removably coupled to anchor 36, including arrangements wherein only some of the cutting knives 34 are removably engagable to anchor 36. It is also to be understood that cutting knife 34 may utilize various surfaces in cutting vegetation, and may be configured as needed or desired per application. For example, structurally strengthening ribbing may be added to one or more surfaces of cutting knives 34. Such ribbing may be integrally formed with cutting knives 34, and efficiently so in molded plastic cutting knives 34. The ribbing may be provided to enhance the weight and strength of the cutting knives 34. As indicated above, any of a variety of materials may be utilized in the manufacture of cutting knives 34. One example material is a suitable molded plastic. Another example material may be a forged steel.

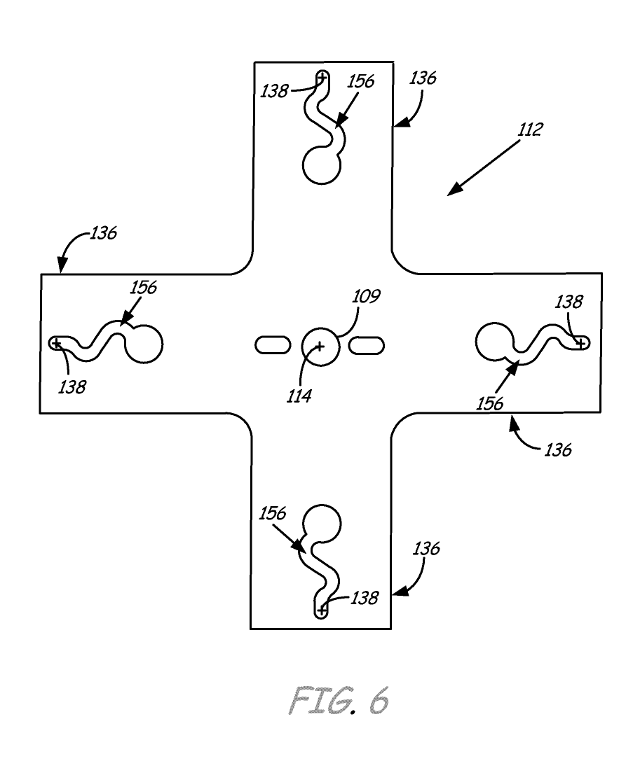

Another embodiment of the present invention is illustrated in FIG. 6, wherein rotatable member 112 may be useful in rotary mowing applications. Rotatable member 112 may comprise a blade mountable at, for example, mounting aperture 109 to a rotating spindle (not shown) of a rotary mower. In the illustrated embodiment, anchors 136 may be integrally formed with rotatable member 112. As described in the previous embodiment, anchor 136 may include one or more receptacle 156 for operably and removably engaging with respective cutting components. Though rotatable member 112 is illustrated with a four-blade design, it is contemplated that any number of blades may be utilized with rotatable member 112, with such blades typically providing symmetry about a first axis of rotation 114.

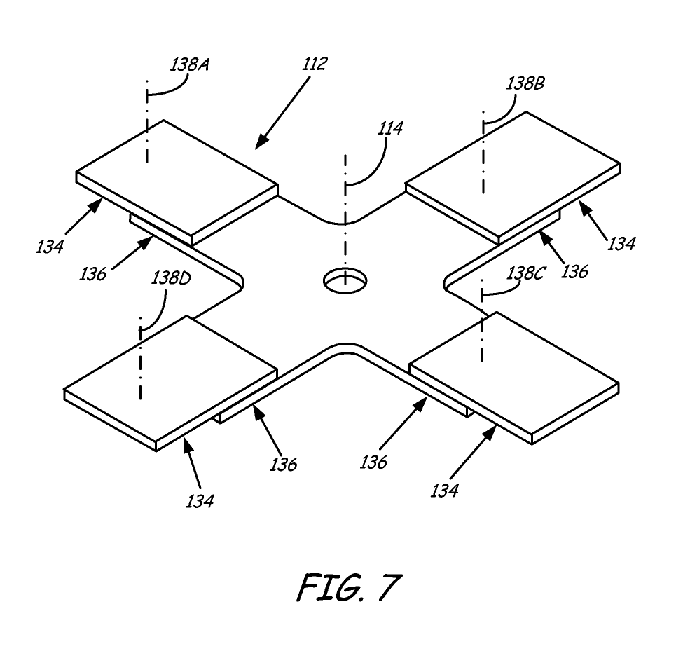

FIG. 7 illustrates a plurality of cutting components 134 removably secured to respective anchors 136 of rotatable member 112. In one embodiment, cutting components 134 may be removably engagable with anchors 136 through a coordinating engagement mechanism similar to that described with respect to FIGS. 1-5. Accordingly, cutting components 134 may be removably and rotatably engaged with anchor 136 about respective second axes of rotation 138A-138D. Moreover, and as described above, cutting components 134 may be fabricated from a variety of materials, including a plastic material, and may further include a reinforcing ribbing configuration. In the embodiment illustrated in FIG. 7, second axes of rotation 138A-38D may be substantially parallel to first axis of rotation 114 of rotatable member 112. In this embodiment, however, first axis of rotation 114 may be substantially perpendicular to a ground surface.

While the engagement mechanism has been described herein as incorporating a protrusion at the cutting component and a corresponding receptacle at the anchor, it is contemplated that such roles may be reversed, and also that a wide variety of other removable engagement mechanisms may be employed in the apparatus of the present invention. As such, it is to be understood that the mechanism for removably engaging cutting components to a rotatable member may assume a wide variety of configurations, with one aspect of the invention being that such configurations enable engagement and disengagement easily and without the use of tools.

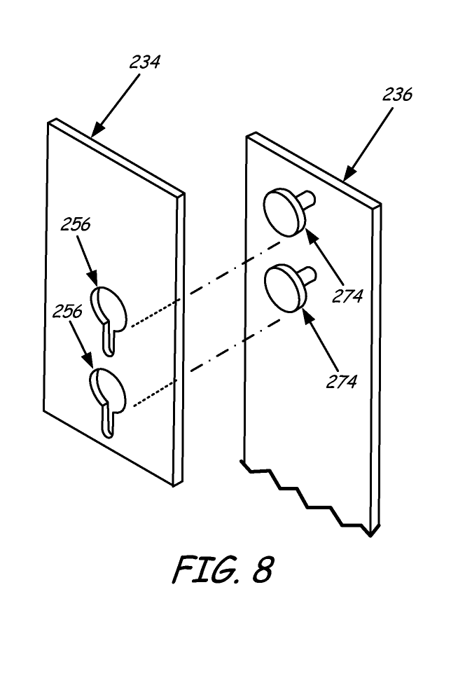

A further embodiment is illustrated in FIG. 8, wherein cutting knife 234 may include a plurality of receptacles 256 in a “key hole” configuration to engage with protrusions 274 at anchor 236. The plurality of protrusions 274 and receptacles 256 enable removable, but non-rotational engagement between cutting knife 234 and anchor 236. As described above, it is contemplated by the present invention to utilize protrusions 274 at cutting knife 234 and receptacles 256 at anchor 236, as desired per application. Moreover, certain applications may utilize one or more protrusions 274 at each of cutting knife 234 and anchor 236, with corresponding receptacles 256 being provided at the respective cutting knife 234 and anchor 236. It is further contemplated that cutting knife 234 and anchor 236 may be utilized in connection with rotatable members rotating about various axes including a respective axes which are substantially parallel to or substantially perpendicular to the ground surface over which vegetation is cut.

The invention has been described herein in considerable detail in order to comply with the patent statutes, and to provide those skilled in the art with the information needed to apply the novel principals and to construct and use embodiments of the invention as required. However, it is to be understood that various modifications may be accomplished without departing from the scope of the invention itself.

What is claimed is:

1. A vegetation cutting apparatus, comprising:
(a) a rotatable member having an anchor and a first axis of rotation; and
(b) a cutting component removably coupled to said anchor, said cutting component being fabricated from a plastic material and being rotatably coupled to said anchor about a second axis of rotation, said cutting component being coupleable to, and decoupleable from, said anchor without tools.

2. A vegetation cutting apparatus as in claim 1 wherein said second axis of rotation is substantially parallel to said first axis of rotation.

3. A vegetation cutting apparatus as in claim 1 wherein said first axis of rotation is substantially parallel to a ground surface.

4. A vegetation cutting apparatus as in claim 1 wherein said anchor is integrally formed with said rotatable member.

5. A vegetation cutting apparatus as in claim 1 wherein said anchor is secured to said rotatable member.

6. A vegetation cutting apparatus as in claim 5 wherein said anchor is welded to said rotatable member.

7. A vegetation cutting apparatus as in claim 1 wherein the operable coupling of said cutting component with said anchor includes a protrusion engaging with a receptacle.

8. A vegetation cutting apparatus as in claim 7 wherein said cutting component includes a main body and said protrusion, said protrusion having a first portion with a first engaging dimension, and a second portion with a second engaging dimension, said first engaging dimension being larger than said second engaging dimension.

9. A vegetation cutting apparatus as in claim 8 wherein said second portion of said protrusion extends between said main body and said first portion of said protrusion.

10. A vegetation cutting apparatus as in claim 9 wherein said first portion is substantially disc-shaped.

11. A vegetation cutting apparatus as in claim 7 wherein said anchor includes said receptacle having a first section configured to removably receive said first and second portions of said protrusion, and a second section configured to removably receive only said second portion of said protrusion.

12. A vegetation cutting apparatus as in claim 11 wherein said first and second sections are contiguous.

13. A vegetation cutting apparatus as in claim 11 wherein said receptacle is a slot.
